(19) United States
(12) Patent Application Publication
(10) Pub. No.: US 2024/0198362 A1
(43) Pub. Date: Jun. 20, 2024

(54) GLUING NOZZLE AND GLUING DEVICE

(71) Applicant: CONTEMPORARY AMPEREX TECHNOLOGY CO., LIMITED, Ningde (CN)

(72) Inventors: Laijuan Yu, Ningde (CN); Anwei Wu, Ningde (CN)

(21) Appl. No.: 18/587,987

(22) Filed: Feb. 27, 2024

Related U.S. Application Data
(63) Continuation of application No. PCT/CN2022/120486, filed on Sep. 22, 2022.

(30) Foreign Application Priority Data
Oct. 14, 2021 (CN) 202122483328.1

(51) Int. Cl. B05B 1/04

(52) U.S. Cl. CPC B05B 1/044

(57) ABSTRACT

The present application relates to a gluing nozzle and a gluing device. The gluing nozzle comprises an inner lined glue nozzle and an outer glue nozzle, wherein the inner lined glue nozzle comprises at least two sub-linings, and the at least two sub-linings are detachably connected and enclosed to form a glue cavity with a glue outlet; and the outer glue nozzle is detachably arranged on an outer side of the inner lined glue nozzle, such that the at least two sub-linings are relatively fixed. The gluing nozzle can solve the current problem that the production cost is increased since frequent replacement of a new glue discharging nozzle is required to ensure the uniformity of glue discharging.

### CROSS-REFERENCE TO RELATED APPLICATIONS

The present application is a continuation of International Application No. PCT/CN2022/120486, filed on Sep. 22, 2022, which claims priority to Chinese Patent Application No. 2021224833281, filed on Oct. 14, 2021 and entitled “GLUING NOZZLE AND GLUING DEVICE”, which is incorporated herein by reference in its entirety.

### TECHNICAL FIELD

The present application relates to the technical field of assembly apparatuses of battery modules, and in particular to a gluing nozzle and a gluing device.

### BACKGROUND ART

Optimization of the group technology of battery modules is an important way to improve the production efficiency of the battery modules, and the battery modules are usually assembled by means of a gluing process. Glue bonding is an effective way to connect batteries into a battery module, which can not only reduce the increase in space and weight brought by structural assembly, but also reduce the assembly cost of the battery module, improves the assembly efficiency, and also ensures the safety of the battery module.

After use of a conventional gluing apparatus, a glue layer that is difficult to clean may be adhered to an inner wall of a gluing nozzle. The uniformity of glue discharging may be affected if the glue layer is accumulated, such that frequent replacement of a new glue discharging nozzle is required to ensure the uniformity of glue discharging, which may lead to an increase in production cost.

### SUMMARY OF THE INVENTION

In view of the above problem, the present application provides a gluing nozzle and a gluing device, which can solve the current problem that the production cost is increased since frequent replacement of a new glue discharging nozzle is required to ensure the uniformity of glue discharging.

In a first aspect, the present application provides a gluing nozzle, including: an inner lined glue nozzle including at least two sub-linings, the at least two sub-linings being detachably connected and enclosed to form a glue cavity with a glue outlet; and an outer glue nozzle detachably arranged on an outer side of the inner lined glue nozzle such that the at least two sub-linings are relatively fixed.

In a technical solution according to an embodiment of the present application, the gluing nozzle includes the inner lined glue nozzle and the outer glue nozzle, and the at least two sub-linings are detachably connected and enclosed to form the glue cavity capable of accommodating glue. In addition, the outer glue nozzle is arranged outside the inner lined glue nozzle and used to further limit the position of each sub-lining, such that the at least two sub-linings are relatively fixed to avoid glue leakage caused by separation between the sub-linings in the process of gluing. In addition, the outer glue nozzle and the inner lined glue nozzle are detachably connected, such that the outer glue nozzle and the inner lined glue nozzle may be separated and the sub-linings may also be separated from each other after gluing is finished. Therefore, the separated sub-linings may be conveniently cleaned individually, the uniformity of glue discharging may be ensured without frequent replacement of the gluing nozzle, and hence an increase in production cost caused by frequently replacing the gluing nozzle may be avoided.

In some embodiments, the outer glue nozzle includes at least two fixing parts, and the at least two fixing parts are detachably connected to form a fixing cavity matching the inner lined glue nozzle.

By providing that the outer glue nozzle includes at least two fixing parts, and the at least two fixing parts are detachably connected to each other to form the fixing cavity matching the inner lined glue nozzle, the outer glue nozzle and the inner lined glue nozzle may be connected more conveniently and quickly. In addition, the fixing parts may be separated from each other after gluing is finished, so as to remove the inner lined glue nozzle from the outer glue nozzle for cleaning.

In some embodiments, the at least two fixing parts are detachably connected into a whole by means of a screw or a bolt.

The detachable connection between the fixing parts is realized by means of the screw or the bolt, such that the fixing parts may be tightly connected, and the outer glue nozzle may not get loose from the inner lined glue nozzle in the process of gluing. Moreover, the detachable connection is realized by using the screw or the bolt, such that the fixing parts may be detached conveniently and quickly after gluing is finished.

In some embodiments, the inner lined glue nozzle is in interference fit with the fixing cavity of the outer glue nozzle.

In this way, the outer glue nozzle may exert an inward extrusion force onto each sub-lining of the inner lined glue nozzle to enable a tighter connection between the sub-linings, so that the sealing performance of the inner lined glue nozzle is improved, and glue leakage from the inner lined glue nozzle is avoided. Therefore, the outer glue nozzle is prevented from being contaminated by the glue and the glue may not be wasted.

In some embodiments, the two adjacent sub-linings are connected by means of a screw or a bolt; and/or one of the two adjacent sub-linings is provided with a limiting boss and the other is provided with a limiting groove matching the limiting boss.

The detachable connection between the two adjacent sub-linings is realized by means of limiting connection between the limiting boss and the limiting groove or threaded connection, such that the sub-linings are convenient to assemble and disassemble.

In some embodiments, there are two sub-linings, and the two sub-linings are arranged opposite to each other to form a glue cavity with a glue outlet.

In the case of an interference fit between the outer glue nozzle and the inner lined glue nozzle, the two sub-linings are arranged opposite to each other. A sealing connection between the two sub-linings may be realized by the extrusion force exerted by the outer glue nozzle. Therefore, the structure is simple, and assembly and disassembly are convenient.

In some embodiments, the material of the sub-lining includes a fluoropolymer and/or silicone.

The fluoropolymer and/or silicone with low surface energy is/are used to form the sub-lining, which makes the glue flow more smoothly in the glue cavity, thus improving the uniformity of glue discharging, reducing the degree of wall hanging after gluing, and facilitating cleaning of the gluing nozzle.

In some embodiments, an end of the inner lined glue nozzle with the glue outlet protrudes from the outer glue nozzle.

The outer glue nozzle is sleeved on the inner lined glue nozzle to limit and support the inner lined glue nozzle, and the end of the inner lined glue nozzle with the glue outlet protrudes out of the outer glue nozzle, such that the outer glue nozzle may be prevented from scratching or scuffing a surface of a substrate in the process of gluing.

In some embodiments, the size of a part of the inner lined glue nozzle protruding out of the outer glue nozzle ranges from 5 mm to 10 mm. On the one hand, the size of the part of the inner lined glue nozzle protruding out of the outer glue nozzle is limited to be greater than or equal to 5 mm, and by ensuring a large size of the part of the inner lined glue nozzle protruding out of the outer glue nozzle, the outer glue nozzle is effectively prevented from scratching or scuffing the surface of the substrate; on the other hand, the size of the part of the inner lined glue nozzle protruding out of the outer glue nozzle is limited to be less than or equal to 10 mm, so as to avoid the case that the inner lined glue nozzle may not be well supported in the process of gluing due to an excessively large size of the part of the inner lined glue nozzle protruding out of the outer glue nozzle.

In a second aspect, the present application provides a gluing device, comprising a gluing nozzle according to the forgoing embodiment.

The above description is only an overview of the technical solutions of the present application. In order to more clearly understand the technical means of the present application to implement same according to the contents of the description, and in order to make the above and other objectives, features and advantages of the present application more obvious and understandable, specific implementations of the present application are exemplarily described below.

### BRIEF DESCRIPTION OF THE DRAWINGS

Various other advantages and benefits will become apparent to those of ordinary skill in the art upon reading the following detailed description of preferred implementations. Accompanying drawings are merely for the purpose of illustrating the preferred implementations and are not to be construed as limiting the present application. Moreover, like components are denoted by like reference signs throughout the accompanying drawings. In the drawings:

FIG. 1 is a schematic structural diagram of a gluing nozzle according to some embodiments of the present application;

FIG. 2 is an exploded view of the gluing nozzle in FIG. 1;

FIG. 3 is a schematic diagram of a sub-lining of an inner lined glue nozzle according to some embodiments of the present application;

FIG. 4 is a schematic diagram of the sub-lining in FIG. 3 from another perspective;

FIG. 5 is a schematic diagram of the sub-lining in FIG. 3 from yet another perspective;

FIG. 6 is a schematic structural diagram of a fixing part of an outer glue nozzle according to some embodiments of the present application; and

FIG. 7 is a schematic structural diagram of another fixing part matching the fixing part in FIG. 6.

### LIST OF REFERENCE SIGNS

100—Inner lined glue nozzle; 110—Sub-lining; 120—Glue cavity; 130—Glue outlet; 200—Outer glue nozzle; 210—Fixing part; 220—Fixing cavity.

### DETAILED DESCRIPTION OF EMBODIMENTS

In order to make the above objectives, features and advantages of the present application more clearly understood, particular embodiments of the present application will be described in detail below with reference to the accompanying drawings. In the following description, numerous specific details are set forth in order to provide a thorough understanding of the present application. However, the present application can be implemented in many other ways different from those described herein, and those skilled in the art can make similar improvements without departing from the essence of the present application. Therefore, the present application is not limited by the particular embodiments disclosed below.

In the description of the present application, it should be understood that the orientation or positional relationships indicated by the terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “anticlockwise”, “axial”, “radial”, “circumferential”, etc. are based on the orientation or positional relationships shown in the accompanying drawings and are merely for case of description of the present application and simplification of the description, rather than indicating or implying that the devices or elements referred to must have a specific orientation or be constructed and operated in a described orientation, and therefore cannot be construed as limiting the present application.

In addition, the terms “first” and “second” are used for descriptive purposes only, and cannot be construed as indicating or implying relative importance or implicitly indicating the number of technical features indicated. Therefore, the features defined with “first” and “second” may explicitly or implicitly include at least one of the features. In the description of the present application, the meaning of “a plurality of” is at least two, such as two, three and so on, unless otherwise specifically defined.

In the present application, unless otherwise explicitly specified and defined, the terms such as “mounting”, “connection”, “connected” and “fixing” should be interpreted broadly, for example, either fixed or detachable connection, or integration; or may be a mechanical connection or an electrical connection; or may be a direct connection or an indirect connection through an intermediate medium, or may be communication between interiors of two elements or interaction between two elements, unless it may be clearly defined otherwise. For those of ordinary skill in the art, the specific meaning of the foregoing terms in the present application may be understood according to specific circumstances.

In the present application, unless otherwise explicitly specified and defined, the expression of a first feature being “on” or “under” a second feature may be the case that the first feature is in direct contact with the second feature, or the first feature is in indirect contact with the second feature via an intermediate medium. Furthermore, the expression of the first feature being “over”, “above” and “on top of” the second feature may be the case that the first feature is directly above or obliquely above the second feature, or only means that the level of the first feature is higher than the second feature. The expression of the first feature being “underneath”, “below” and “beneath” the second feature may be the case that the first feature is directly below or obliquely below the second feature, or only means that the level of the first feature is less than the second feature.

Battery modules are widely used in power consuming devices such as vehicles, ships or aircrafts. Moreover, the optimization of the group technology of the battery modules is an important way to improve the production efficiency of the battery modules, and the battery modules are usually assembled by means of a gluing process. Glue bonding is an effective way to connect batteries into a battery module, which can not only reduce the increase in space and weight brought by structural assembly, but also reduce the assembly cost of the battery module, improves the assembly efficiency, and also ensures the safety of the battery module.

In an assembly process of the battery module, after use of a gluing apparatus for gluing, a glue layer that is difficult to clean may be adhered to an inner wall of a gluing nozzle. The uniformity of glue discharging may be affected if the glue layer is accumulated, such that frequent replacement of a new gluing nozzle is required to ensure the uniformity of glue discharging, which may lead to an increase in production cost. Based on the above considerations, it is necessary to provide a gluing nozzle to solve the current problem that the production cost is increased since frequent replacement of a new glue discharging nozzle is required to ensure the uniformity of glue discharging.

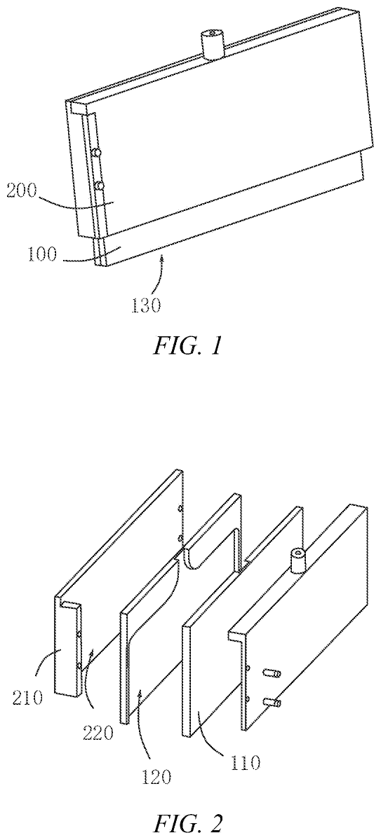

References are made to FIGS. 1 and 2, in which FIG. 1 is a schematic structural diagram of a gluing nozzle according to some embodiments of the present application, and FIG. 2 is an exploded view of the gluing nozzle in FIG. 1. An embodiment of the present application provides a gluing nozzle, including an inner lined glue nozzle 100 and an outer glue nozzle 200. The inner lined glue nozzle 100 includes at least two sub-linings 110, and the at least two sub-linings 110 are detachably connected and enclosed to form a glue cavity 120 with a glue outlet 130.

It can be understood that the inner lined glue nozzle 100 is connected to a glue supply portion of a gluing apparatus. In the process of gluing, glue enters the glue cavity 120 of the inner lined glue nozzle 100, and then leaves the inner lined glue nozzle 100 through the glue outlet 130 to be applied to a substrate. The outer glue nozzle 200 is detachably arranged on an outer side of the inner lined glue nozzle 100, such that the at least two sub-linings 110 are relatively fixed. By providing the outer glue nozzle 200, the detachably connected sub-linings 110 are connected together more tightly to improve the scaling performance of the inner lined glue nozzle 100.

In a technical solution of an embodiment of the present application, the gluing nozzle includes the inner lined glue nozzle 100 and the outer glue nozzle 200, the at least two sub-linings 110 are detachably connected to each other and enclosed to form the glue cavity 120 capable of accommodating the glue, and the outer glue nozzle 200 is arranged outside the inner lined glue nozzle 100. The outer glue nozzle 200 is used to further limit the position of each sub-lining 110, such that the at least two sub-linings 110 are relatively fixed to avoid glue leakage caused by separation between the sub-linings 110 in the process of gluing. In addition, the outer glue nozzle 200 and the inner lined glue nozzle 100 are detachably connected, such that the outer glue nozzle 200 and the inner lined glue nozzle 100 may be separated and the sub-linings 110 may also be separated from each other after gluing is finished. Therefore, the separated sub-linings 110 may be conveniently cleaned individually, the uniformity of glue discharging may be ensured without frequent replacement of the gluing nozzle, and hence an increase in production cost caused by frequently replacing the gluing nozzle may be avoided.

In the above embodiment, the inner lined glue nozzle 100 includes at least two sub-linings 110. Specifically, in some embodiments, the inner lined glue nozzle 100 includes two sub-linings 110, and the two sub-linings 110 are enclosed to form the glue cavity 120. For example, the glue cavity 120 in the gluing nozzle is relatively narrow in the case that the gluing nozzle is a flat and wide gluing nozzle, so it is difficult to clean the gluing nozzle directly. By providing that the inner lined glue nozzle 100 includes two sub-linings 110, the two sub-linings 110 are butted and enclosed to form the glue cavity 120 in a required shape. Besides, after gluing is finished, an inner wall of the inner lined glue nozzle 100 may be exposed by separating the two sub-linings 110, so as to facilitate cleaning.

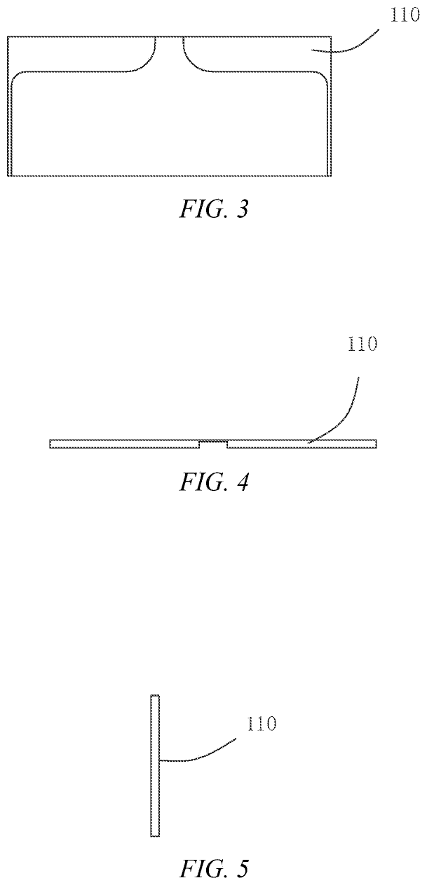

Referring to FIGS. 3 to 5, in some embodiments, the two sub-linings 110 may be designed into structures of the same shape and size or may be designed into structures of different shapes and sizes. For example, in a specific embodiment, when a required cross-sectional shape of the glue cavity 120 is rectangular, the cross sections of the two sub-linings 110 are set to be “[”-shaped, or the cross sections of the two sub-linings 110 are set to be “L”-shaped, and the two sub-linings 110 are butted and enclosed to form a rectangle. For example, in another specific embodiment, the cross section of one sub-lining 110 is set to be “[”-shaped, the cross section of the other sub-lining 110 is set to be “|”-shaped, and the two sub-linings 110 are butted and enclosed to form a rectangle.

In some other embodiments, the inner lined glue nozzle 100 includes three or more sub-linings 110. For example, in a specific embodiment, the sub-lining 110 has an “L”-shaped cross section, and the three sub-linings 110 may be enclosed to form a rectangle.

In some embodiments, in order to make the outer glue nozzle 200 better fix the at least two sub-linings 110 relatively, the material of the outer glue nozzle 200 is set to be hard metal or alloy to provide better support.

In some embodiments, the outer glue nozzle 200 includes at least two fixing parts 210, and the at least two fixing parts 210 are detachably connected to form a fixing cavity 220 matching the inner lined glue nozzle 100. By providing that the outer glue nozzle 200 includes at least two fixing parts 210, and the at least two fixing parts 210 are detachably connected to each other to form the fixing cavity 220 matching the inner lined glue nozzle 100, the outer glue nozzle 200 and the inner lined glue nozzle 100 may be connected more conveniently and quickly.

For example, in a specific embodiment, the process of connection between the outer glue nozzle 200 and the inner lined glue nozzle 100 is described as below: after the sub-linings 110 of the inner lined glue nozzle 100 are connected to each other, the fixing parts 210 of the outer glue nozzle 200 are arranged around the outer side of the inner lined glue nozzle 100, and then the fixing parts 210 are connected and fixed to each other, to realize the connection between the outer glue nozzle 200 and the inner lined glue nozzle 100, which solves the problem of alignment between the outer glue nozzle 200 and the inner lined glue nozzle 100 and improves the assembly efficiency. In addition, the fixing parts 210 may be separated from each other after gluing is finished, so as to remove the inner lined glue nozzle 100 from the outer glue nozzle 200 for cleaning.

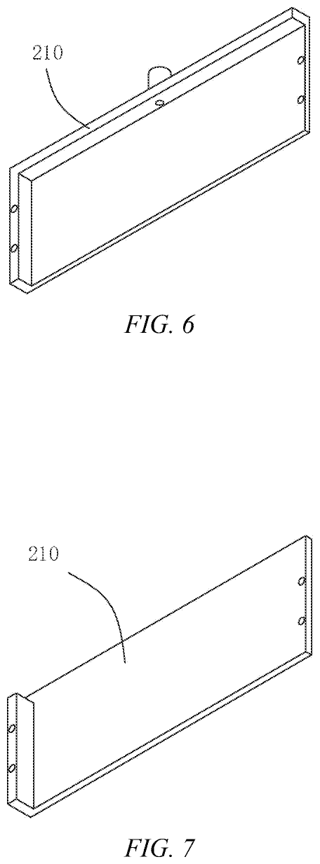

There may be two, three or more fixing parts 210. For example, in a specific embodiment, referring to FIGS. 2, 6 and 7, there are two fixing parts 210, and the two fixing parts 210 are respectively provided with rectangular main body fixing plates arranged opposite to each other. One edge of one fixing part 210 is provided with a side fixing plate. Two edges of the other fixing part 210 are provided with side fixing plates. The two main body fixing plates and the three side fixing plates are enclosed to form a three-dimensional space with a rectangular cross section, with one end opened to allow glue discharging from the glue outlet 130 of the inner lined glue nozzle 100. The number of the fixing parts 210 may be specifically set according to the shape of the gluing nozzle and actual demands.

In some embodiments, the outer glue nozzle 200 may form a fully enclosed structure or a non-fully enclosed structure.

Specifically, in some embodiments, the fixing parts 210 of the outer glue nozzle 200 are enclosed to form a cylindrical structure, such that the outer glue nozzle 200 and the inner lined glue nozzle 100 form a socketed structure. At this time, an area of contact between the inner lined glue nozzle 100 and the outer glue nozzle 200 is maximized, such that the outer glue nozzle 200 has a favorable fixing effect on each sub-lining 110 of the inner lined glue nozzle 100. In some other embodiments, the fixing parts 210 of the outer glue nozzle 200 are combined to form an annular netted structure or a partially hollowed-out structure, such that the material required by the outer glue nozzle 200 is reduced while the sub-linings 110 of the inner lined glue nozzle 100 are fixed, and hence the cost is saved.

In some embodiments, the at least two fixing parts 210 are detachably connected by means of a screw or a bolt.

The detachable connection between the fixing parts 210 is realized by means of the screw or the bolt, such that the fixing parts 210 may be tightly connected, and the outer glue nozzle 200 may not get loose from the inner lined glue nozzle 100 in the process of gluing. Moreover, the detachable connection is realized by using the screw or the bolt, such that the fixing parts 210 may be detached conveniently and quickly after gluing is finished. For example, in a specific embodiment, the outer glue nozzle 200 includes two fixing parts 210 arranged opposite to each other, and the two fixing parts 210 are provided with threaded holes. Before gluing is started, the two fixing parts 210 are fixed by a screw to achieve fixation of each sub-lining 110 of the inner lined glue nozzle 100. After the gluing is finished, the screw is removed to detach each fixing part 210 of the outer glue nozzle 200, so as to remove the inner lined glue nozzle 100 for cleaning.

In some embodiments, the inner lined glue nozzle 100 is in interference fit with the fixing cavity 220 of the outer glue nozzle 200, such that the outer glue nozzle 200 may exert an inward extrusion force onto each sub-lining 110 of the inner lined glue nozzle 100 to enable a tighter connection between the sub-linings 110, so that the sealing performance of the inner lined glue nozzle 100 is improved, and glue leakage from the inner lined glue nozzle 100 is avoided. Therefore, the outer glue nozzle 200 is prevented from being contaminated by the glue and the glue may not be wasted. Specifically, in the case that the cross section of the inner lined glue nozzle 100 is rectangular, the cross section of the fixing cavity 220 formed by the outer glue nozzle 200 is also rectangular, and the inner lined glue nozzle 100 is in interference fit with the fixing cavity 220. In the case that the cross section of the inner lined glue nozzle 100 is square, round, oval, waist-shaped or a combination thereof, the shape of the fixing cavity 220 formed by the outer glue nozzle 200 matches therewith, and the two are in interference fit, such that the sealing performance of the inner lined glue nozzle 100 is improved, and glue leakage between adjacent sub-linings 110 is prevented from contaminating the outer glue nozzle 200 or causing waste of the glue.

In some embodiments, the two adjacent sub-linings 110 are connected by means of a screw or a bolt.

The detachable connection between the two adjacent sub-linings 110 is realized by means of threaded connection, such that the sub-linings 110 are easy to disassemble and assemble, have a high assembly efficiency before gluing and may be disassembled quickly after gluing. Therefore, time required for cleaning is shortened. In a specific embodiment, the sub-lining 110 is provided with a threaded hole, and the two sub-linings 110 are fixed by screwing a screw or a bolt into the threaded holes of the two sub-linings 110.

In some embodiments, one of the two adjacent sub-linings 110 is provided with a limiting boss and the other is provided with a limiting groove matching the limiting boss. The detachable connection between the two adjacent sub-linings 110 is realized by means of limiting connection between the limiting boss and the limiting groove, such that the sub-linings 110 are convenient to assemble and disassemble, have a high assembly efficiency before gluing, and may be disassembled quickly after gluing. Therefore, time required for cleaning is shortened.

In a specific embodiment, the inner lined glue nozzle 100 includes two sub-linings 110 arranged opposite to each other. One of the two sub-linings 110 is provided with a limiting boss on an opposite end surface, and the other is provided with a limiting groove matching the limiting boss. With a glue discharging direction as a depth direction of the glue cavity 120, the limiting boss and the limiting groove cooperate to realize limiting of the two sub-linings 110 in the depth direction of the glue cavity 120, and together with a fixing function of the outer glue nozzle 200, the two sub-linings 110 are relatively fixed in a circumferential direction of the glue cavity 120.

In some embodiments, one of the two adjacent sub-linings 110 is provided with a limiting boss and the other is provided with a limiting groove matching the limiting boss. The limiting between the two sub-linings 110 is realized through cooperation of the limiting boss and the limiting groove. In addition, the sub-lining 110 is further provided with a threaded hole. The two adjacent sub-linings 110 are further fixed by a screw.

In some embodiments, there may be two sub-linings 110, and the two sub-linings 110 are arranged opposite to each other to form a glue cavity 120 with a glue outlet 130. In the case of an interference fit between the outer glue nozzle 200 and the inner lined glue nozzle 100, the two sub-linings 110 are arranged opposite to each other. A scaling connection between the two sub-linings 110 may be realized by the extrusion force exerted by the outer glue nozzle 200. Therefore, the structure is simple, and disassembly and assembly are convenient.

In a specific embodiment, the gluing nozzle is a wide glue discharging nozzle, i.e., the size of the inner lined glue nozzle 100 in a first direction is larger than that in a second direction, the first direction is perpendicular to the second direction, and both of the first direction and the second direction are perpendicular to the glue discharging direction. In this case, there is a small space available between the two sub-linings 110. The two sub-linings 110 are arranged opposite to each other, which makes the two sub-linings 110 be simple in structure. Combined with the interference fit between the outer glue nozzle 200 and the inner lined glue nozzle 100, the sub-lining 110 of the inner lined glue nozzle 100 is fixed by the outer glue nozzle 200, and the structure of the inner lined glue nozzle 100 is also simplified, thereby preventing a complicated structure in the inner lined glue nozzle 100 from affecting glue discharging.

In some embodiments, the material of the sub-lining 110 includes a fluoropolymer and/or silicone. The fluoropolymer and/or silicone with low surface energy is/are used to form the sub-lining 110, which makes the glue flow more smoothly in the glue cavity 120, thus improving the uniformity of glue discharging, reducing the degree of wall hanging after gluing, and facilitating cleaning of the gluing nozzle. In a specific embodiment, the sub-lining 110 is made from polytetrafluoroethylene, which makes the glue flow more smoothly in the glue cavity 120, thereby improving the uniformity of glue discharging, reducing the degree of glue hanging on the wall after gluing, and facilitating the cleaning of the gluing nozzle.

In some embodiments, an end of the inner lined glue nozzle 100 with the glue outlet 130 protrudes from the outer glue nozzle 200.

The outer glue nozzle 200 is sleeved on the inner lined glue nozzle 100 to limit and support the inner lined glue nozzle 100, and the end of the inner lined glue nozzle 100 with the glue outlet 130 protrudes out of the outer glue nozzle 200, such that the outer glue nozzle 200 may be prevented from scratching or scuffing a surface of a substrate in the process of gluing.

In some embodiments, the size of a part of the inner lined glue nozzle 100 protruding out of the outer glue nozzle 200 ranges from 5 mm to 10 mm. On the one hand, the size of the part of the inner lined glue nozzle 100 protruding out of the outer glue nozzle 200 is limited to be greater than or equal to 5 mm, and by ensuring a large size of the part of the inner lined glue nozzle 100 protruding out of the outer glue nozzle 200, the outer glue nozzle 200 is effectively prevented from scratching or scuffing the surface of the substrate; on the other hand, the size of the part of the inner lined glue nozzle 100 protruding out of the outer glue nozzle 200 is limited to be less than or equal to 10 mm, so as to avoid the case that the inner lined glue nozzle 100 may not be well supported in the process of gluing due to an excessively large size of the part of the inner lined glue nozzle 100 protruding out of the outer glue nozzle 200.

According to some embodiments of the present application, the present application further provides a gluing device that includes the gluing nozzle in the forgoing embodiments. Since the gluing device includes all the technical features of the gluing nozzle described above, the gluing device has all the technical effects of the foregoing embodiments, which is not repeated herein.

The various technical features of the above embodiments can be combined in any manner, and in order to simplify the description, not all possible combinations of the various technical features of the above embodiments are described. However, as long as there is no conflict between the combinations of these technical features, they should be considered to be within the scope of the description in this application.

The above embodiments merely describe several implementations of this application more specifically and in more detail, but cannot be thus understood as a limitation to the patent scope of this application. It should be noted that those of ordinary skill in the art can make some variations and improvements without departing from the concept of the present application, and the variations and improvements fall within the scope of protection of the present application.

What is claimed is:

1. A gluing nozzle, comprising:
an inner lined glue nozzle comprising at least two sub-linings, the at least two sub-linings being detachably connected and enclosed to form a glue cavity with a glue outlet; and
an outer glue nozzle detachably arranged on an outer side of the inner lined glue nozzle such that the at least two sub-linings are relatively fixed.

2. The gluing nozzle according to claim 1, wherein the outer glue nozzle comprises at least two fixing parts, the at least two fixing parts being detachably connected to form a fixing cavity matching the inner lined glue nozzle.

3. The gluing nozzle according to claim 2, wherein the at least two fixing parts are detachably connected into a whole by means of a screw or a bolt.

4. The gluing nozzle according to claim 2, wherein the inner lined glue nozzle is in interference fit with the fixing cavity of the outer glue nozzle.

5. The gluing nozzle according to claim 1, wherein the two adjacent sub-linings are connected by means of a screw or a bolt; and/or
one of the two adjacent sub-linings is provided with a limiting boss, and the other is provided with a limiting groove matching the limiting boss.

6. The gluing nozzle according to claim 1, wherein the number of the sub-linings is two, and the two sub-linings are arranged opposite to each other to form the glue cavity with the glue outlet.

7. The gluing nozzle according to claim 1, wherein the material of the sub-lining comprises a fluoropolymer and/or silicone.

8. The gluing nozzle according to claim 1, wherein an end of the inner lined glue nozzle with the glue outlet protrudes from the outer glue nozzle.

9. The gluing nozzle according to claim 8, wherein the size of a part of the inner lined glue nozzle protruding from the outer glue nozzle ranges from 5 mm to 10 mm.

10. A gluing device, comprising a gluing nozzle as defined in claim 1.
